(19) United States
(12) Patent Application Publication
(10) Pub. No.: US 2016/0261956 A1
(43) Pub. Date: Sep. 8, 2016

(54) ELECTROMAGNETIC TRANSDUCER FOR GENERATING VIBRATIONS FOR SOUND AND/OR WORDS BONE CONDUCTION

(71) Applicant: TMPGEST DI FEDELI DANILA & C. S.A.S., Milano Mi (IT)

(72) Inventors: Paolo COLLINI, Milano (MI) (IT); Marco COLLINI, Milano (MI) (IT)

(21) Appl. No.: 15/032,476

(22) PCT Filed: Oct. 29, 2014
(86) PCT No.: PCT/IB2014/065695

§ 371 Date: Apr. 27, 2016

(30) Foreign Application Priority Data
Oct. 29, 2013 (IT) MI2013A001797

(51) Int. Cl. H04R 9/02; H04R 1/28; G02C 11/00; H04R 1/02

(52) U.S. Cl. CPC H04R 9/02; H04R 1/028; H04R 1/288; H04R 1/025; G02C 11/10; H04R 2209/027; H04R 2307/027; H04R 2460/13

(57) ABSTRACT

An electromagnetic transducer for generating vibrations for sounds and/or words bone conduction which comprises a magnetic yoke comprising a ferromagnetic material base plate (2), a magnetic pole (3), a voice coil (4) positioned around the magnetic pole (3), a pair of permanent magnets (5) positioned outside the voice coil (4) and a vibrating diaphragm (8) of ferromagnetic material supported by the non-ferromagnetic support (7). Advantageously, such support (7) is supported by the base plate (2) by fastening brackets (8) that engage portions of the support (7) that project beyond the base plate (2) and exceed opposite ends of the base plate (2).

The present invention, refers to an electromagnetic transducer for generating vibrations for sounds and/or words bone conduction in accordance with the preamble of claim 1.

Nowadays, transducers of the type specified above are becoming increasingly more popular than conventional types of earphones. This depends on the fact that bone conduction technology allows a user to be able to listen to music, sounds and words without necessarily having to insert earphones inside the ears or having to wear annoying headphones.

Indeed, in the case of an electromagnetic transducer for generating vibrations for sounds and/or words bone conduction, it is sufficient for such a transducer to come into contact with a portion of the head in which bones are not particularly protected from soft parts like muscles or fat, so that the user can listen to sounds and/or words in a clear manner and irrespective of the external noise that can be perceived with the hearing apparatus.

For instance U.S. Pat. No. 4,628,907 discloses a direct contact hearing aid apparatus adapted to be mounted deep within the ear canal, said apparatus including an output electromechanical transducer for converting audio output signals into mechanical movement of an output coupling element without the production of discernible sound waves to prevent acoustic feedback.

Furthermore WO 2012/045852 discloses a hearing aid system incorporating an electromagnetic actuator comprising one or more permanent magnets.

In the case of motorcyclists or skiers, a further possibility is that of applying the electromagnetic transducer to the body of the helmet worn by the user so as to ensure a correct listening of sounds and/or words by the user.

On the other hand, the use of magnetic transducers for sounds and/or words bone conduction has a drawback in terms of the audio quality with which the user is able to clearly and authentically perceive the sounds and/or the words. In order to ensure clear and authentic audio quality the specific shape that is used for the electromagnetic transducer is an essential element. Unfortunately, as it has been possible to observe, the best results can be achieved but only with magnetic transducers for sounds and/or words bone conduction having dimensions and bulk that are rather large.

Concerning the use of electromagnetic transducer for generating vibrations for sounds and/or words bone conduction having dimensions that are not suitably miniaturised or small does not create too many problems if combined with a helmet, it is clear however how this is not the case for other types of uses.

For example, in the case of an eyeglass frame the arrangement of an electromagnetic transducer for generating vibrations for sounds and/or words bone conduction is quite problematic, especially in the case in which the dimensions of the aforementioned transducer are not very small, when trying to house it in the temples of the eye glass without affecting the appearance of the eyeglass itself negatively.

In respect to what has been outlined above, it is clear how there is the strong desire to make an electromagnetic transducer for generating vibrations for sounds and/or words bone conduction which has excellent performance in terms of quality and authenticity of the sounds or of the words to be reproduced, has small bulk and dimensions, so as to allow it to be housed also in objects having small dimensions, for example temples of an eyeglass frame.

The problem forming the basis of the present invention is that of devising an electromagnetic transducer for generating vibrations for sounds and/or words bone conduction having structural and functional characteristics such as to satisfy the aforementioned requirement, while at the same time avoiding the drawbacks that were mentioned with reference to the prior art.

Such a drawback is solved with an electromagnetic transducer for generating vibrations tor sounds and/or words bone conduction in accordance with the characteristics of claim 1.

According to one further aspect; such a problem is moreover solved with an object according to claim 14, as well as with an eyeglass frame in accordance with claim 15, comprising a housing in which an electromagnetic transducer for generating vibrations for sounds and/or words bone conduction according to the invention is received.

Further characteristics and advantages of the electromagnetic transducer for generating vibrations for sounds and/or words bone conduction according to the present invention, shall become clearer from the following description of some of its preferred embodiments, given as an indication and not for limiting purposes, with reference to the attached figures, in which:

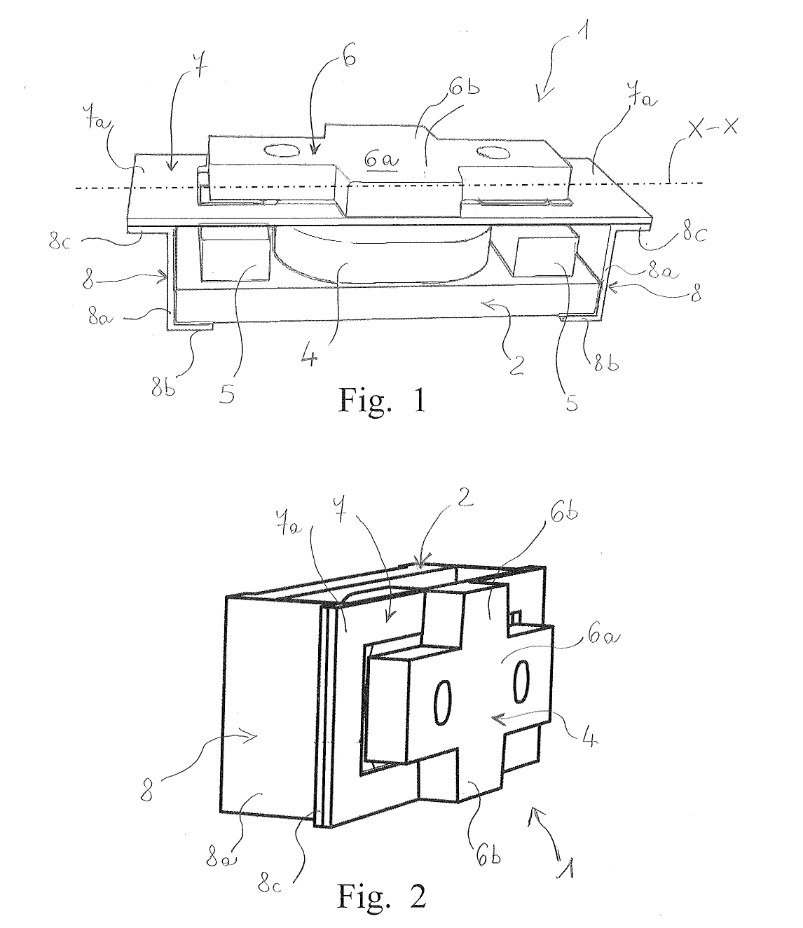

FIG. 1 represents a perspective view of an electromagnetic transducer for generating vibrations for sounds and/or words bone conduction according to the present invention;

FIG. 2 represents a perspective view of the electromagnetic transducer of FIG. 1 according to a different angle;

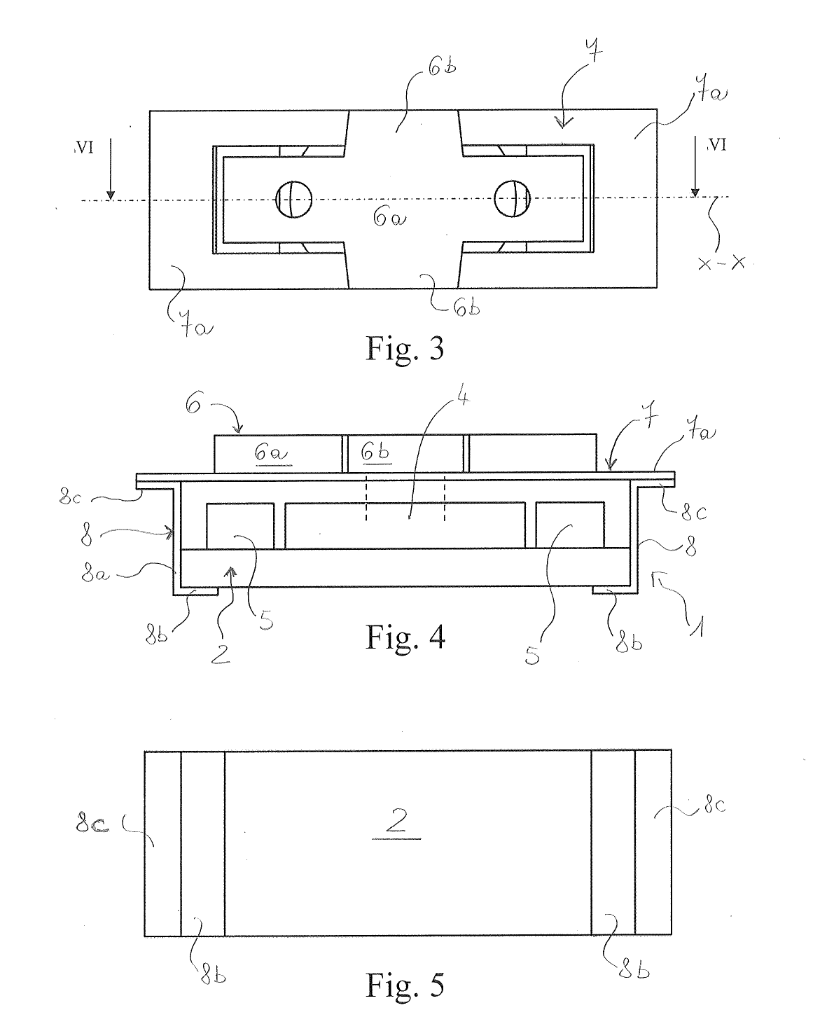

FIGS. 3, 4 and 5 represent views of the electromagnetic transducer of FIG. 1, from the top, side and from below, respectively;

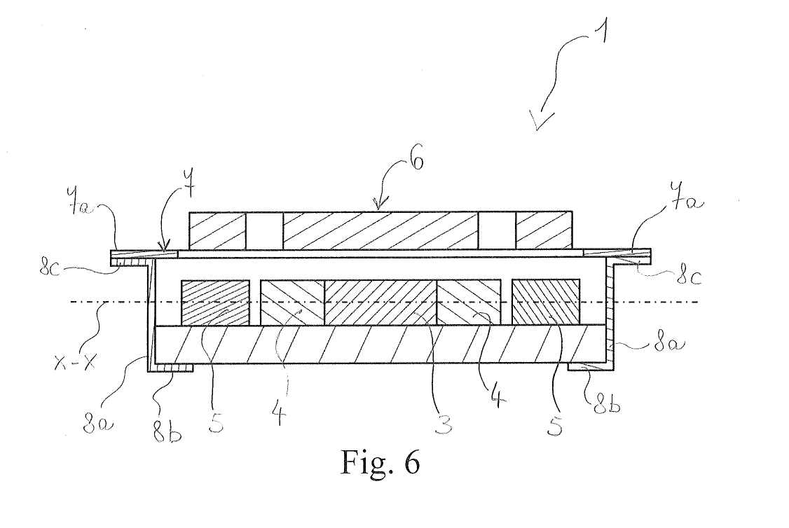

FIG. 6 represents a longitudinal section plan view according to the section line VI-VI of FIG. 3;

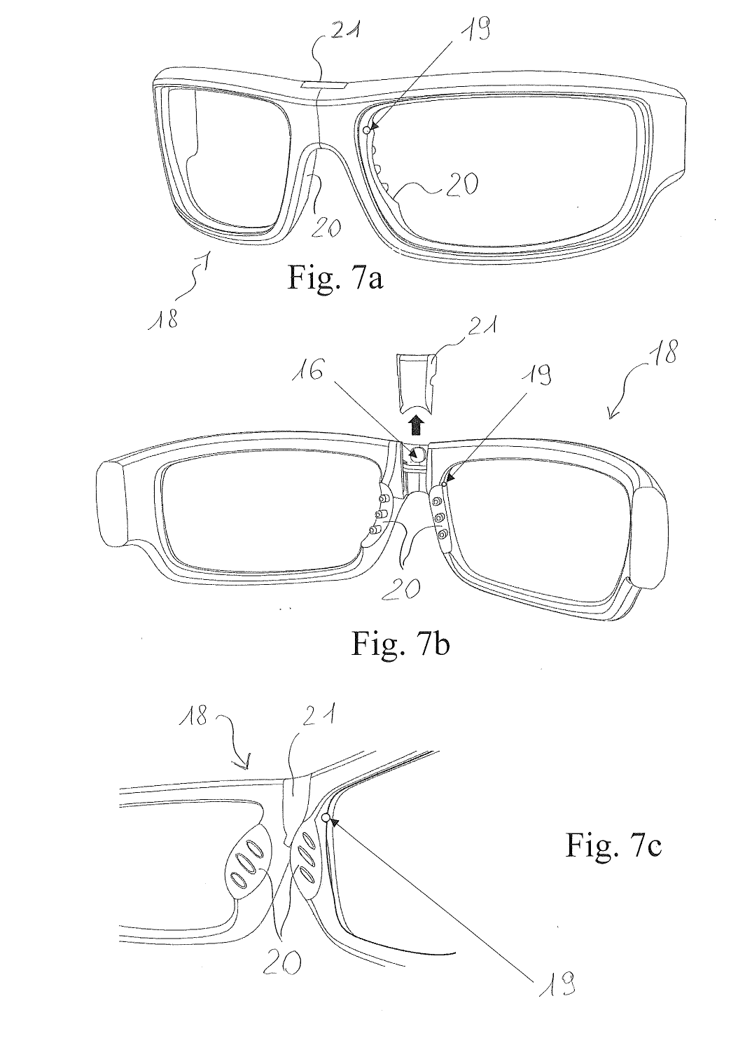

FIG. 7a represents a simplified perspective view of the outer side of a frame front for eyeglass in the temple of which the electromagnetic transducer for generating vibrations for sounds and/or words bone conduction of FIG. 1 is housed;

FIG. 7b represents a perspective view from the inner side of the frame front of FIG. 7a;

FIG. 7c represents a detail of FIG. 7b according to a different point of view;

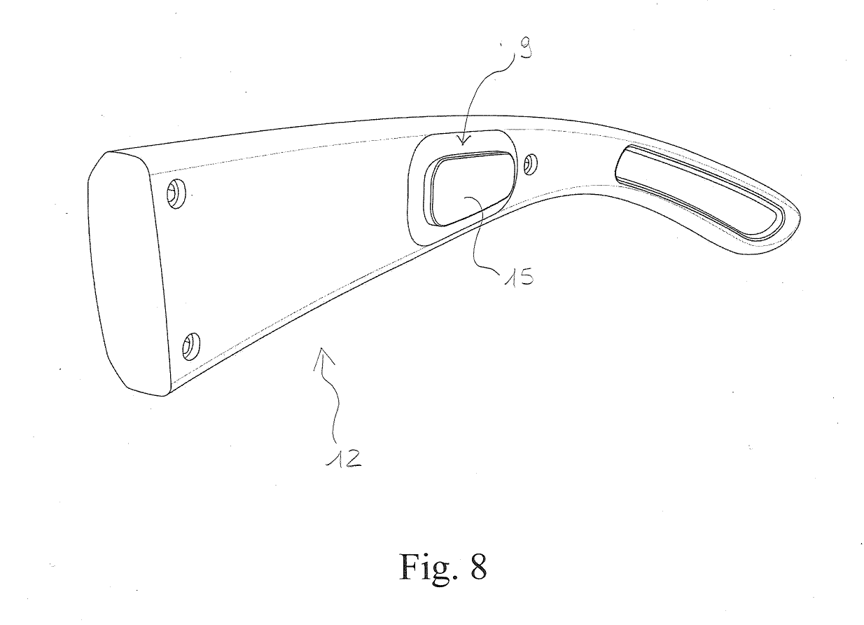

FIG. 8 represents a perspective view of a single temple of the eyeglass frame of FIG. 1;

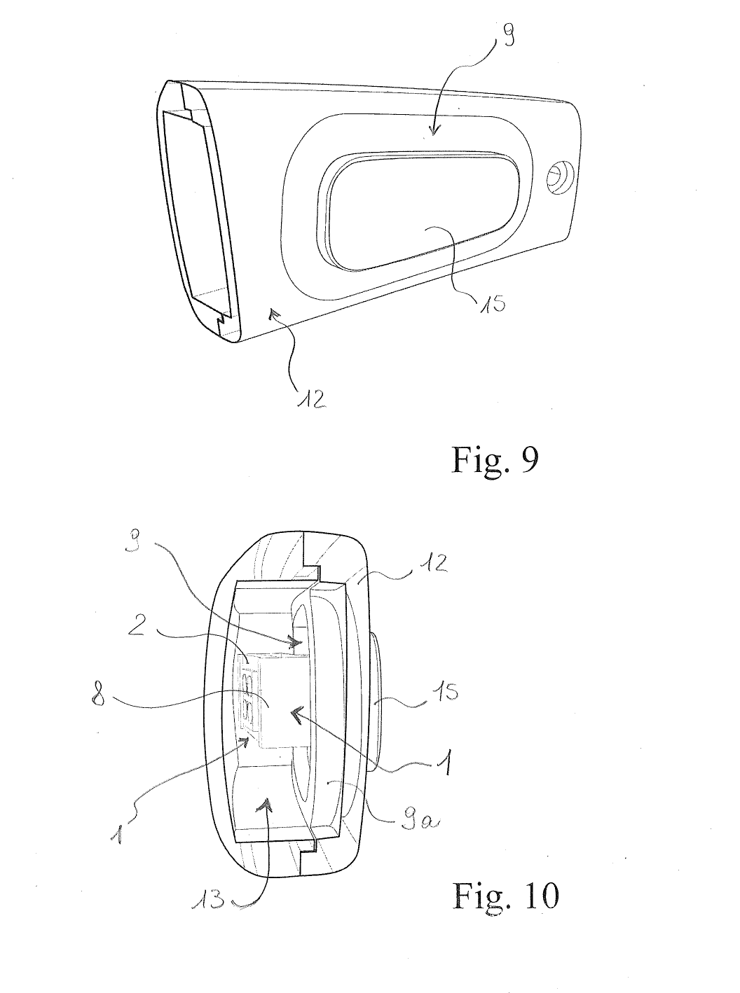

FIG. 9 represents an enlarged view of the temple for an eyeglass frame of FIG. 8;

FIG. 10 represents a partially sectioned side view of the detail of FIG. 9;

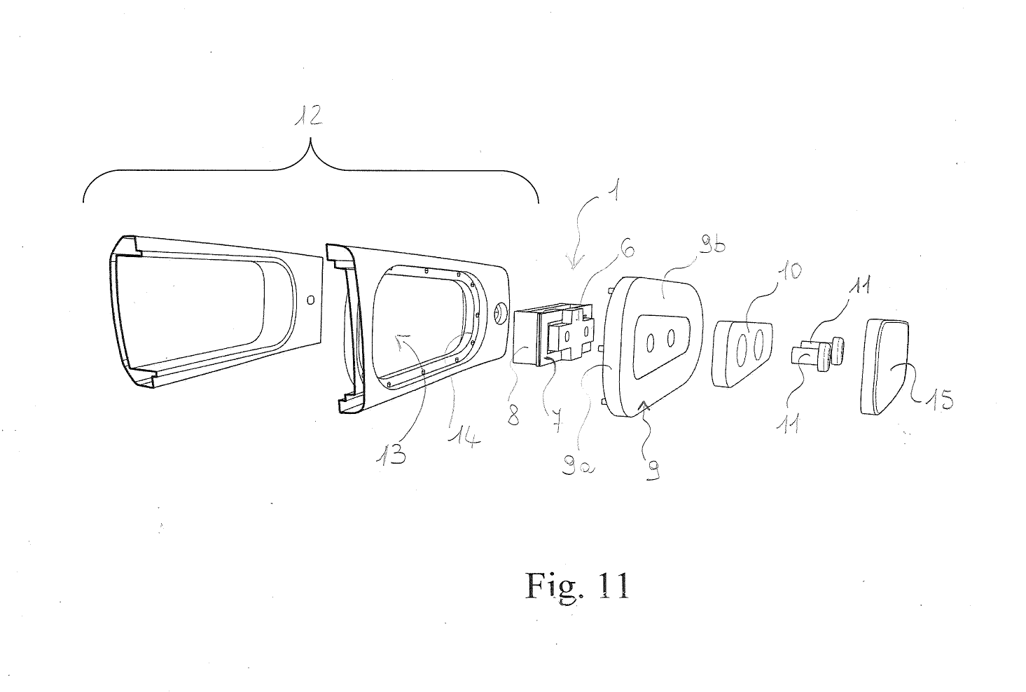

FIG. 11 represents an exploded view of the detail of FIG. 9;

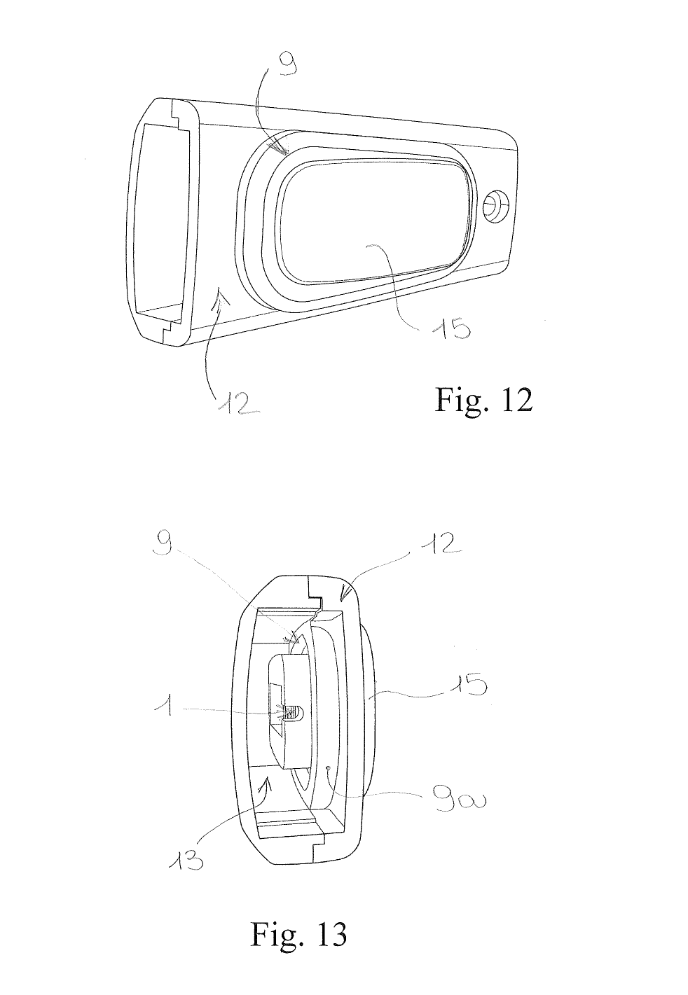

FIG. 12 represents an enlargement of a detail of the temple of the eyeglass frame of FIG. 7 according to a variant embodiment;

FIG. 13 represents a partially sectioned side view of the detail of FIG. 12;

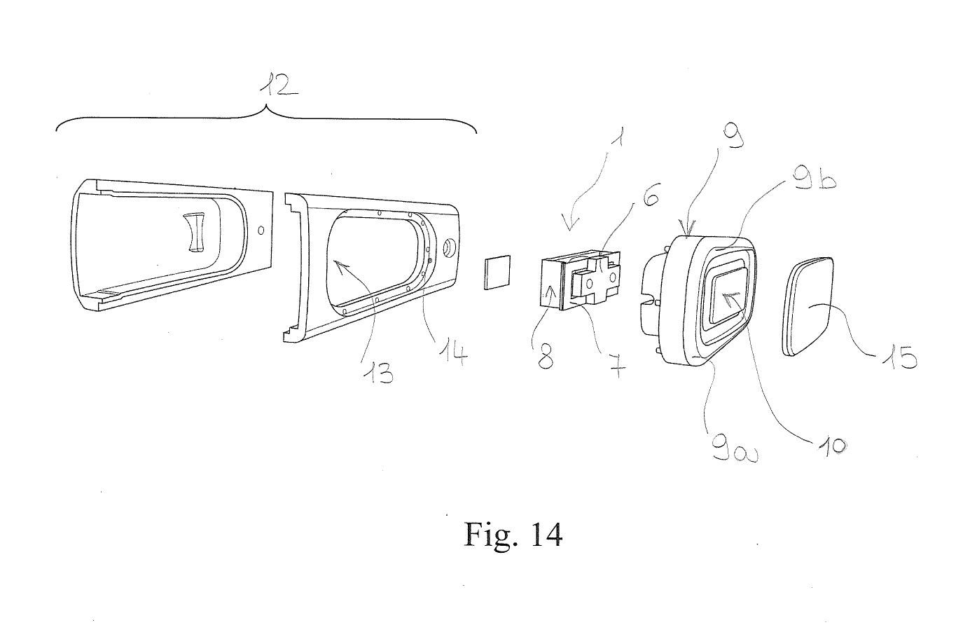

FIG. 14 represents an exploded view of the detail of FIG. 12.

With reference to the attached figures, in particular to FIGS. 1 to 6, reference numeral 1 wholly indicates an electromagnetic transducer for generating vibrations for sounds and/or words bone conduction according to the invention.

The electromagnetic transducer 1 comprises a magnetic yoke comprising:

a base plate 2 of ferromagnetic material having an elongated shape in a first direction X-X so that in the aforementioned base plate 2 two long sides 2b and two short sides 2a can be identified substantially extending parallel and, respectively, perpendicular with respect to said first direction X-X; according to the illustrated embodiment, the base plate 2 of ferromagnetic material has a rectangular shape;

a magnetic, pole 3 protruding axially from a central area of the base plate 2 of ferromagnetic material, said magnetic pole 3 having an elongated shape in the aforementioned first direction X-X perpendicular to the axis of said magnetic pole 3;

a voice coil 4 positioned around the magnetic pole 3, said voice coil 4 having an elongated shape in the aforementioned first direction X-X with reference to the elongated shape of the magnetic pole 3 around which it is positioned;

a pair of permanent magnets 5 that are positioned outside the voice coil 4, each permanent magnet 5 of the aforementioned pair of permanent magnets being positioned near to a respective short side 2a of the base plate 2 of ferromagnetic material, so that the voice coil 4 is positioned and comprised between the aforementioned pair of permanent magnets 5 along the aforementioned first direction X-X;

a vibrating diaphragm 6 of ferromagnetic material and
fixing means for supporting and separating the aforementioned vibrating diaphragm 6 from the base plate 2 of ferromagnetic material, so that the vibrating diaphragm 6 is substantially parallel and faces the base plate 2 of ferromagnetic material and the voice coil 4 and the permanent magnets 5 are comprised between the base plate 2 of ferromagnetic material and the vibrating diaphragm 6.

The aforementioned fixing means comprise non-ferromagnetic support means 7 for interrupting the direct magnetic continuity of the vibrating diaphragm 6 with said base plate 2 of ferromagnetic material.

It is worth highlighting that the aforementioned vibrating diaphragm 6 is spaced by a suitable air gap from the aforementioned magnetic pole 3, from the voice coil 4 as well as from the aforementioned pair of magnets.

According to the invention the aforementioned non-ferromagnetic support means 7 extend along the aforementioned first direction X-X so as to exceed the aforementioned short sides 2a of the base plate 2 of ferromagnetic material with respective end portions 7a.

For each of the two aforementioned short sides 2a of the base plate 2 of ferromagnetic material the aforementioned fixing means comprise a respective fastening bracket 8 that connects one short side 2a of the base plate 2 of ferromagnetic material with the respective end portion 7a exceeding said short side 2a, thus ensuring with this the support of the vibrating diaphragm 6 to the base plate 2 of ferromagnetic material according to the aforementioned parallel position, facing and spaced away from the base plate 2 of ferromagnetic material.

It is worth highlighting that in accordance with the preferred embodiment illustrated in the figures:

each fastening bracket 8 comprises a central core 8a which extends between opposite longitudinal ends from each of which a respective end wing 8b,8c projects, inclined with respect to the straight line joining the aforementioned opposite ends of the central portion;

the end wings of each fastening bracket 8 are inclined in an opposite manner from one another with respect to the straight line joining said opposite ends of the central core 8a and

a first wing 8b of each fastening bracket 8 being fixed to a short side 2a of said base plate 2 of ferromagnetic material, the second wing 8c of each fastening bracket 8 being fixed to the end portion 7a of said non-ferromagnetic support means 7, that is to say to one of the two portions of the non-ferromagnetic support means 7 which exceed the short sides 2a of the base plate 2 of ferromagnetic material.

Preferably, the aforementioned second wing 8c of each fastening bracket 8 defines a flat portion coupled with a corresponding and matching end portion 7a of said non-ferromagnetic support means 7.

Preferably, each fastening bracket 8 comprises a fiat central core 8a from the ends of which the aforementioned end wings 8b,8c project at a right angle with respect to the central core 8a with inclinations chat are opposite one another.

Preferably, the aforementioned non-ferromagnetic support means 7 define a support frame, which:

is supported at the aforementioned end portions 7a by the portions 8c of the fastening brackets 8 so as to substantially be parallel to the base plate 2 of ferromagnetic material;

delimits a central opening in correspondence of which the vibrating diaphragm 6 is positioned;
is fixed to the vibrating diaphragm 6 in correspondence of two separate side portions, so as to allow the vibrating diaphragm 6 to be able to vibrate.

Preferably, the vibrating diaphragm 6 and the aforementioned support frame 7 are fixed to one another in correspondence of two opposite median portions defined with reference to the first direction X-X, the opposite portions of the vibrating diaphragm 6 that are distal with respect to said median portions overhanging said median portions.

Preferably, the vibrating diaphragm 6 substantially has a straight cross shape, in which from a rectangular core 6a arranged with the long sides 2b parallel with respect to said first direction X-X project two due opposite side portions 6b for fixing to the aforementioned support frame.

Preferably, the central opening defined by said support frame extends in said first direction X-X so as to exceed the aforementioned distal portions of the vibrating diaphragm 6.

Preferably, the bulk in plan of the vibrating diaphragm 6 is circumscribed in the bulk in plan of the base plate 2 of ferromagnetic material.

With specific reference to the use of the electromagnetic transducer 1, this is intended to be fixed and housed in a special housing seat 13 of an object 12.

In accordance with the preferred embodiments illustrated in figures from 7 to 14, the aforementioned object 12 is made up, as a non-limiting example, of a temple of an eyeglass frame.

The aforementioned eyeglass frame comprises a frame front 18, provided with nose pads 20, from which two respective and opposite temples 12 project.

In the thickness of at least one of the two temples 12, in the example in both the temples 12, it is foreseen for there to be a housing 13 in which the aforementioned electromagnetic transducer 1 is contained.

Preferably the magnetic yoke of the electromagnetic transducer 1 is supported and kept in position inside the aforementioned housing seat 13 of the temple 12 by means of a resilient material element 9, in such a way that the electromagnetic transducer 1 is supported with elastic suspension by said resilient material element 9.

In accordance with the embodiment illustrated in FIGS. 9 to 11, the transducer according to the invention comprises a plate 10 for transmitting vibrations which is integrally and rigidly coupled with the vibrating diaphragm 6 through engaging means 11, which specifically comprise fixing screws 11 which engage corresponding holes foreseen both on the vibrating diaphragm 6 and in the aforementioned plate 10. As an alternative to what is described, it is clear that other fixing means can be foreseen as an alternative to the use of the aforementioned fixing screws 11 that are a preferred embodiment.

As illustrated in figures from 9 to 11, the vibrating diaphragm 6 and the plate 10 are integrally and rigidly coupled to one another by the aforementioned fixing screws 11 with the interposition, between them, of the portion of the aforementioned resilient material element 3 that secures said support with elastic suspension of the electromagnetic transducer to the aforementioned resilient material element 9.

Again with reference to the embodiment illustrated in FIGS. 9 to 11, the resilient material element 9 is highlighted comprising a perimetral edge 9a that delimits a substantially flat wall 9b, said substantially flat wall 9b being the aforementioned portion of the resilient material element 9 which is interposed between the vibrating diaphragm 6 and the plate 10 so as to secure the aforementioned support with the elastic suspension of the electromagnetic transducer 1 with respect to the temple 12.

The aforementioned perimetral edge 9a of the resilient material element 9 is engagingly shape coupled between matching profiles with a corresponding perimetral edge 14 that delimits the opening for accessing the housing seat 13 thus ensuring that the resilient material element 9 is fixed to the temple 12 and therefore the support with elastic suspension of the electromagnetic transducer 1 inside the housing seat 13, avoiding any direct contact (this without the interposition of a resilient material that is capable of softening the vibration) between the magnetic yoke of the electromagnetic transducer 1 and the walls of the temple 12 of the eyeglass frame.

With reference to the embodiment illustrated in FIGS. 12 to 14, the resilient material element 9 defines a hollow containment body inside which the electromagnetic transducer 1 is inserted and kept. The resilient material element 9 comprises a perimetral edge 9a that delimits a substantially fiat front wall 9b, to which the plate 10 Is directly applied for transmitting vibrations coming from the vibrating diaphragm 6 of the electromagnetic transducer 1. Specifically, the plate 10 can be glued to the wall 9b of the resilient material element 9 or, more preferably, the aforementioned wall 9b can comprise a through opening that is delimited by a perimetral edge with which the perimetral edge of the plate 10 is engaged, with shape coupling between matching profiles.

Concerning now the fixing of the resilient material element 9 to the temple 12, this is obtained through a shape coupling between matching profiles of the aforementioned perimetral edge 9a of the resilient material element 9 with a corresponding perimetral edge 14 that defines the opening for accessing the housing seat 13, Such a fixing modality thus makes it possible to obtain the fixing of the resilient material element 9 to the temple 12 with elastic suspension of the electromagnetic transducer 1 inside the housing seat 13, avoiding any direct contact (i.e. without the interposition of a resilient material that is capable of softening the vibration) between the magnetic yoke of the electromagnetic transducer 1 and the temple 12 of the eyeglass frame.

Advantageously, this makes it possible to avoid, or at least strongly reduce, that the vibrations of the electromagnetic transducer 1 propagate also to the object 12. In the case in which the aforementioned object 12 comprises a microphone that is associated with its structure, and the user of the object 12 is having an audio conversation, for example a telephone conversation, with an interlocutor, the absence of vibrations transmitted by the electromagnetic transducer to the object 12 itself makes it possible to prevent such vibrations from being picked up by the aforementioned microphone that is mounted at the edge of the object 12 itself generating an annoying echo return that is perceived by the aforementioned interlocutor.

In both the embodiments illustrated and described above, there is moreover a lid 15 which is associated with the side of the respective plate 10 that is opposite the side of such a plate 10 facing the vibrating diaphragm 6 of the electromagnetic transducer 1. Such a lid 15 carries out the double function of hiding the plate 10 (and the fixing means 11 in the case of the embodiment of FIGS. 9 to 11) as well as of ensuring the transmission of the vibrations from the vibrating diaphragm 6 of the electromagnetic transducer 1 to the portion of the body of the user which is in contact with such a lid 15, in the example a user wearing the eye glass comprising the temples 12 in the housing seats 13 of which the electromagnetic transducers 1 are housed.

With reference to the aforementioned eyeglass frame, it is worth highlighting how it is preferably also provided with a microphone 16 for picking up the sounds and the words emitted by the user wearing the eyeglass frame itself and sending them to a suitable voice transmission system. In this hypothesis, the aforementioned microphone 16 is preferably housed, in a position that is protected, inside a cavity of the frame front 18. In order to allow words and/or sounds to reach the microphone 16 from outside the aforementioned cavity, the frame front 18 is provided with at least one through hole 19 (in the example of FIGS. 7b and 7c there are two through holes 19) for connecting the inside of the aforementioned cavity present inside the frame front 18 with the outside of the frame front.

In accordance with one preferred embodiment, the aforementioned microphone 16 is housed in a cavity obtained in correspondence of the central portion of the frame front 18, more specifically in the portion comprised between the two nose pads 20, preferably above such nose pads.

As can be seen in FIG. 7b, by removing a lid 21 it is possible to access the microphone 16 for possible maintenance operations.

Differently, it is possible to provide a frame for eyeglass in which the aforementioned microphone is positioned in correspondence of one of the two side portions of the frame front, that is to say near to a portion where the frame front 16 is connected, in an articulated manner, to a respective temple. With reference to the frame front 18 of the eyeglass frame, it is worth highlighting now in it an inner side (cf, FIG. 7b) facing towards the face of the user wearing the eyeglass frame and an opposite outer side (cf. FIG. 7a) can be defined. With this said, it is worth highlighting how the aforementioned hole 19, through which the sounds and/or the voices reach from outside to the microphone 16, it is advantageously positioned in correspondence of the aforementioned inner side of the frame front.

This makes it possible for the microphone 16 to pick up the sounds and/or the words emitted from the mouth of the user wearing the eyeglass frame in a correct and efficient manner, without being disturbed by elements such as wind that hits the eyeglass frame.

In accordance with what can be understood in FIGS. 7a, 7b and 7c, each through hole 19 extends from the aforementioned inner cavity of the frame front 18 so as to emerge outside the frame front 18 in correspondence of a point of such a frame front 18 positioned in the groove, or against it, in which the lenses (not illustrated) are inserted and held. More in detail, the through hole 19 emerges out from the frame front 18 at a point that is further back than the respective lens with respect to the outer side of the frame front. After the tests carried out, such a positioning of the through holes 19 was found to be preferred since the lens makes it possible to obtain an effective wind barrier, preventing the microphone from detecting crackles and the like, despite being very close to the mouth of the user wearing the eyeglass frame.

Also in the case in which the cavity intended for housing the microphone is positioned in correspondence of one of the two side portions of the frame front, in accordance with the different embodiment previously described, it is advantageous for the through hole in communication with the aforementioned cavity to emerge near to or inside the groove in which the lenses are inserted, in a position that is further back than the lens with respect to the outer side of the frame front.

As can be appreciated from what has been described, the electromagnetic transducer for generating vibrations for sounds and/or words bone conduction according to the present invention makes it possible to satisfy the aforementioned requirement and to overcome at the same time the drawbacks referred to in the introductory part of the present description with reference to the prior art.

In particular, as was found through testing, the structure of the electromagnetic transducer for generating vibrations for sounds and/or words bone conduction despite having small dimensions and bulk, makes it possible to ensure an excellent transduction of the sounds and/or words perceived by the user. This depends upon the fact that the structure of the electromagnetic transducer with the ends of the aforementioned non-ferromagnetic support means that exceed both the aforementioned short sides of the base plate, as well as the simultaneous connection of the wings of the fastening brackets to such projecting ends, make it possible to leave high freedom to the vibrating diaphragm to be able to vibrate due to the variations of the magnetic field induced by the voice coil, despite the very small dimensions of such components.

Furthermore, the aforementioned characteristic of the electromagnetic transducer of being supported with elastic suspension makes it possible to avoid, or in any case to reduce, that the vibrations generated by the electromechanical transducer are directly transmitted, i.e. interposition of one layer of resilient and softening material, to the object in which said transducer is housed.

Yet a further advantage coming from using the electromagnetic transducer for generating vibrations for sounds and/or words bone conduction according to the invention comes from the simplicity of its structure which ensures a good operation over time and allows it to be produced in automated production lines.

Of course, a man skilled in the art, with the purpose of satisfying contingent and specific requirements, can carry out numerous modifications and variants to the electromagnetic transducer for generating vibrations for sounds and/or words bone conduction described above, all moreover covered by the scope of protection of the invention as defined in the following claims.

1-20. (canceled)

21. An electromagnetic transducer for generating vibrations for sounds and/or words bone conduction, including a magnetic yoke comprising:
a ferromagnetic material base plate elongated in a first direction, in the ferromagnetic material base plate being detectable two long sides and two short sides extending parallel and perpendicular to the first direction, respectively;
a magnetic pole projecting axially from a central area of the ferromagnetic material base plate, and the magnetic pole having an elongated shape in the first direction perpendicular to the magnetic pole axis;
a voice coil positioned around the magnetic pole, and the voice coif having an elongated shape in the first direction in agreement with the elongated shape of the magnetic pole;
a pair of permanent magnets positioned outside the voice coil, and each permanent magnet of the pair of permanent magnets being positioned close and along a respective short side of the ferromagnetic material base plate so that the voice coil results positioned between the pair of permanent magnets along the first direction;
a ferromagnetic material vibrating diaphragm;
fixing means for supporting and spacing the vibrating diaphragm from the ferromagnetic material base plate so that the vibrating diaphragm is parallel to and facing to the ferromagnetic material base plate, with the voice coil and the permanent magnets included between the ferromagnetic material base plate and the vibrating diaphragm,
wherein:
the fixing means comprise non-ferromagnetic supporting means for interrupting the magnetic direct continuity of the vibrating diaphragm with the ferromagnetic material base plate, and
the vibrating diaphragm is spaced by an air gap from the magnetic pole, from the voice coil and from the pair of magnets,
the non-ferromagnetic support means extend along the first direction in order to exceed both aforementioned short sides of the ferromagnetic material base plate with respective end sections, and
for each short side of the ferromagnetic material base plate the fixing means include a respective fastening bracket that connects a respective short side of the ferromagnetic material base plate with the respective end portion exceeding the short side, thereby ensuring the support of the vibrating diaphragm to the ferromagnetic material base plate in the parallel position, facing and spaced from the ferromagnetic material base plate.

22. The electromagnetic transducer according to claim 21, wherein:
each fastening bracket comprises a central core extending between opposite longitudinal ends from each of them projects a respective wing end inclined relative to the straight line connecting the opposite ends of the central core;
the wings ends of each fastening bracket are inclined in the opposite manner between them compared to the straight line connecting the opposite ends of the central core, and
a first wing of each fastening bracket is fixed to a short side of the ferromagnetic material base plate, and the second wing of each fastening bracket is fixed to the end portion of the non-ferromagnetic support means, that exceeds the short side of the ferromagnetic material base plate.

23. The electromagnetic transducer according to claim 22, wherein the second wing of each fastening bracket locates a flat portion coupled to a corresponding and complementary end portion of the non-ferromagnetic support means.

24. The electromagnetic transducer according to claim 22, wherein each fastening bracket comprises a central flat core from thereof ends overhang aforesaid end wings which are flat and are substantially inclined at right angle with respect to the central core.

25. The electromagnetic transducer according to claim 21, wherein the non-ferromagnetic support means identify a supporting frame which:
is supported by the mounting brackets parallel to the ferromagnetic material base plate;
delimits a central opening in correspondence of which is positioned the vibrating diaphragm;
is fixed to the vibrating diaphragm in correspondence of two distinct lateral portions leaving to the vibrating diaphragm the opportunity to vibrate.

26. The electromagnetic transducer according to claim 25, wherein the vibrating diaphragm and the supporting frame are fixed to each other in correspondence of two opposite median portions located with reference to the first direction, the opposed portions of the vibrating diaphragm distal from the median portions resulting to be in overhang from the median portions.

27. The electromagnetic transducer according to claim 28, wherein the vibrating diaphragm presents a substantially straight cross shape, and from a rectangular core, arranged with the long sides in parallel to the first direction, overhang two opposite median side portions for fixing to the supporting frame.

28. The electromagnetic transducer according to claim 28, wherein the central opening located by the supporting frame extends in the first direction in order to overhang the distal portions of the vibrating diaphragm.

29. The electromagnetic transducer according to claim 21, wherein plan dimensions of the vibrating diaphragm is limited by plan dimensions of the ferromagnetic material base plate.

30. The electromagnetic transducer according to claim 21, wherein the magnetic yoke is supported and maintained in position by a resilient material element with respect to an object to which the transducer is fixed so as to result supported with elastic suspension from the resilient material element.

31. The electromagnetic transducer according to claim 30, wherein the resilient material element defines a hollow containment body inside which the electromagnetic transducer is housed and retained.

32. The electromagnetic transducer according to claim 30, wherein:
the element of resilient material comprises a plate for transmitting vibrations received from the vibrating diaphragm, and
the element of resilient material comprises a front through opening delimited by a perimetral edge with which a perimetral edge of the plate engages through shape coupling between matching profiles so that the plate is integrally coupled with the vibrating diaphragm so as to be set in vibration by it.

33. The electromagnetic transducer according to claim 30, comprising a plate for transmission of vibrations, the plate being integrally and rigidly coupled to the vibrating diaphragm by engaging means, wherein the vibrating diaphragm and the plate are rigidly coupled to each other integrally from the engagement means, with interposition among them of a portion of the resilient material element, which ensures the support with elastic suspension of the magnetic yoke to the element of resilient material.

34. An object comprising a housing in which an electromagnetic transducer is received for generating vibrations for sounds and/or words bone conduction, and the electromagnetic transducer is according to claim 21, wherein the support of the electromagnetic transducer in the housing is ensured by a resilient material element so as to soften propagation of vibrations from the magnetic yoke toward the object and thereby avoiding direct contact between the magnetic yoke and the housing.

35. An eyeglass frame comprising a frame front, provided with nose pads, and with opposite temples projecting out from the frame front, wherein:
the frame front comprises an inner side facing the face of the user wearing the frame for eyeglass and an opposite outer side,
inside the thickness of at least one of the two temples, preferably inside both temples, a housing is foreseen in which an electromagnetic transducer is housed for generating vibrations for sounds and/or words bone conduction,
the electromagnetic transducer is an electromagnetic transducer according to claim 21,
the support of the electromagnetic transducer in the housing is ensured by means of a resilient material element so as to soften the propagation of vibration from the magnetic yoke towards the object and thereby avoiding direct contact between the magnetic yoke and the housing.

36. The eyeglass frame according to claim 35, comprising a microphone for picking up sounds and/or words emitted by the user wearing the eyeglass frame, wherein:
the microphone is housed in a position protected inside a cavity made in the frame front, and
the frame front comprises a through hole to place the cavity, in which the microphone is housed, in communication with the external environment of the frame front.

37. The eyeglass frame according to claim 38, wherein the hole extends from the inner cavity to a portion positioned at the inner side of the frame front.

38. The eyeglass frame according to claim 37, wherein the through hole extends from the inner cavity up to a portion positioned near to a groove of the frame front intended for housing and holding a lens.

39. The eyeglass frame according to claim 36, wherein the microphone is housed inside a cavity made in correspondence of a central portion of the frame front comprised between the nose pads.

40. The eyeglass frame according to claim 38, wherein the microphone is housed inside a cavity positioned in correspondence of one of the two side portions of the frame front where the frame front is connected in an articulated manner to a respective temple.
